(19) United States
(12) Patent Application Publication
(10) Pub. No.: US 2003/0039747 A1
(43) Pub. Date: Feb. 27, 2003

(54) Method of enhancing waveguide photosensitivity and waveguide having enhanced photosensitivity

(75) Inventors: Evelyn Boettcher, Greenbelt, MD (US); Sandeep T. Vohra, Ellicott City, MD (US)

Correspondence Address: PILLSBURY WINTHROP, LLP, P.O. BOX 10500, MCLEAN, VA, 22102, US

(73) Assignee: Optinel Systems,Inc., Elkridge, MD

(21) Appl. No.: 09/938,543

(22) Filed: Aug. 27, 2001

(51) Int. Cl. B05D 5/06

(52) U.S. Cl. 427/162

(57) ABSTRACT

A method enhances photosensitivity of an optical element by disposing the optical element in a confinement chamber, introducing a hydrogen-rich atmosphere into the confinement chamber and regulating temperature of the hydrogen-rich atmosphere over a treatment time. The temperature regulation includes increasing the temperature of the hydrogen-rich atmosphere over a portion of the treatment time. A method for producing an optical element includes exposing the optical element to a hydrogen-rich atmosphere for a treatment period of time varying temperature of the hydrogen-rich atmosphere during the treatment period and irradiating the optical element with electromagnetic radiation.

### BACKGROUND

1. Field of Invention

This invention pertains generally to methods of enhancing photosensitivity of waveguides and waveguides having enhanced photosensitivity, and particularly to methods of enhancing photosensitivity of waveguides by hydrogen loading and the photosensitivity enhanced waveguides.

2. Description of Related Art

Refractive index variations can be written into silica or silicon optical waveguides by exposing the waveguides to actinic radiation, such as ultraviolet light. The photosensitivity of the waveguides can be enhanced by exposing the waveguides to hydrogen so that the waveguides absorb the hydrogen (“hydrogen loading”).

There is currently a great demand for efficiently and accurately produced optical components for optical communications systems such as optical fibers that have Bragg fiber gratings and optical fibers that have chirped gratings. Currently, hydrogen loading of waveguides, such as fiber or planar waveguides, is performed by placing the waveguide in a high pressure environment at a fixed temperature, usually below 250° C. In the case of an optical fiber, the temperature is more typically maintained at a fixed temperature below 100° C. since prolonged exposure to high temperature damages the protective coating on the optical fiber. This usually requires maintaining the optical fiber at a fixed temperature for several days in order to enhance the photosensitivity of the optical fiber. Furthermore, when the enhanced fibers are removed from the pressure vessel at the elevated temperature, hydrogen diffuses out of the optical fiber faster than it does at room temperature, thus leading to a decreased shelf-life for such enhanced optical fibers.

### SUMMARY

Therefore, an object of the current invention is to provide a method of enhancing photosensitivity of a waveguide by more efficient hydrogen loading of the optical waveguide.

Another object of the invention is to provide a method of producing optical waveguides that have an improved photosensitivity shelf-life.

Another object of this invention is to provide a method of enhancing photosensitivity of optical waveguides in a more flexible and controllable way.

These and other objects of the invention are realized by providing a method of enhancing photosensitivity of an optical element by disposing the optical element in a confinement chamber, introducing a hydrogen-rich atmosphere into the confinement chamber, and regulating the temperature of the hydrogen-rich atmosphere over a treatment time. The temperature regulating includes increasing the temperature of the hydrogen-rich atmosphere over a portion of the treatment time.

Another embodiment of this invention provides a method of producing an optical element by exposing the optical element to a hydrogen-rich atmosphere for a treatment period of time, varying the temperature of the hydrogen-rich atmosphere during the treatment period, and irradiating the optical element with electromagnetic radiation.

Another embodiment of this invention provides a method of producing an optical element by exposing a high photosensitivity optical fiber to a hydrogen-rich atmosphere for a treatment period of time, regulating a hydrogen partial pressure of the hydrogen-rich atmosphere during a treatment period of time, and irradiating a high photosensitivity optical fiber with electromagnetic radiation. Regulating the hydrogen partial pressure may include maintaining the hydrogen partial pressure below one atmosphere during the treatment period of time.

### BRIEF DESCRIPTION OF THE DRAWINGS

FIG. 1 is a schematic illustration of exemplary temperature profiles of a hydrogen-rich atmosphere using the method of enhancing photosensitivity of an optical waveguide according to an embodiment of the invention; and

FIG. 2 is a schematic illustration of exemplary pressure profiles corresponding to the embodiments of FIG. 1.

### DETAILED DESCRIPTION OF EMBODIMENTS OF THE INVENTION

A first embodiment of the invention is directed to a method of enhancing photosensitivity of an optical element. An optical element is disposed in a confinement chamber. A pressure vessel is a suitable confinement chamber when high pressure treatment is desired. The optical element may be an optical fiber, but may include bulk optical elements or other types of optical waveguides. Silica-based optical fibers are suitable to use with this method of enhancing photosensitivity according to this invention. Further, germanium-doped optical fibers including highly doped high-sensitivity optical fibers are suitable to use with this method of the invention.

A hydrogen-rich atmosphere is introduced into the confinement chamber and the temperature of the hydrogen-rich atmosphere is regulated over a treatment time period.

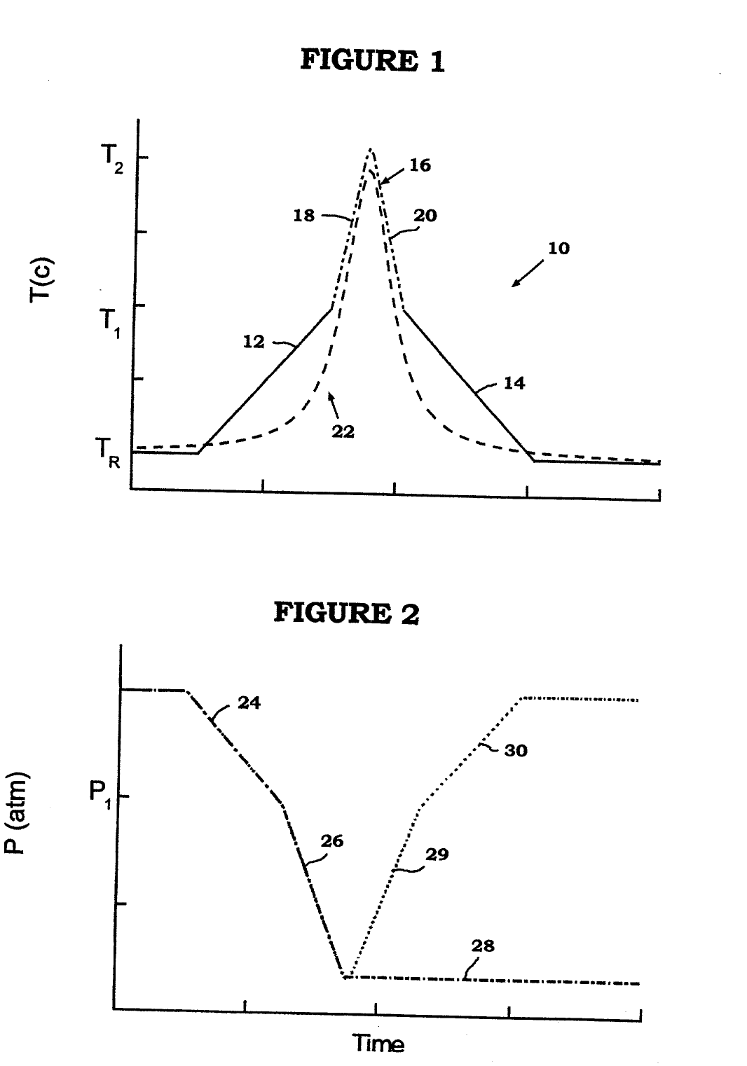

FIG. 1 is a schematic illustration of a temperature profile 10 of the hydrogen-rich atmosphere over a treatment time period. The temperature of the hydrogen-rich atmosphere is increased 12 over a portion of the treatment time and decreased 14 over another portion of the treatment time. The increase in temperature 12 followed by a decrease in temperature 14 will be referred to as a ramp-up and a ramp-down, respectively, temperature variation. The ramp-up temperature 12 and ramp-down temperature 14 are illustrated as being linear in this schematic illustration, but this is not necessary under the broader concepts of the invention. The temperature profile 10 of the hydrogen-rich atmosphere over the treatment time may also include a spike temperature variation portion 16. The spike temperature variation 16 includes a temperature increase 18 which increases much more rapidly as a function of time than the temperature increase 12 during the ramp-up portion of the temperature profile 10. The spike 16 also includes a rapid temperature decrease 20 over another treatment period of time. The spike portion of the temperature variation 16 of the hydrogen-rich atmosphere provides a much more rapid temperature variation than the ramp-up 12 and ramp-down 14 portions of the temperature variation.

In some applications of this embodiment of the invention, only ramp-up and ramp-down portions may be used, while in other applications a temperature spike variation in addition to the ramp-up and ramp-down temperature variations may be used. Again, the spike portion is illustrated as comprising linear portions 18 and 20. The scope of the invention is not limited only to linear variations 18 and 20 of the spike temperature variation 16. In addition, FIG. 1 illustrates a discontinuity between the slope of the ramp-up portion 12 and the spike portion 18 as well as a discontinuity between the slope of the spike portion 20 and the ramp-down portion 14. The scope of the invention includes situations where a smooth curve in temperature first varies slowly and then varies rapidly to provide an effective ramp-up and spike type of profile as illustrated by the dashed curve 22 in FIG. 1. Similarly, the scope of the invention includes situations where there are many sections of temperature variations along the treatment period selected according to the desired application. The ramp-up and ramp-down and ramp-and-spike temperature profiles are meant to have a broad meaning covering all such cases.

The temperature of the hydrogen-rich atmosphere at the beginning and end of the treatment period will be substantially the same temperature T_{R} according to an aspect of the invention. The surrounding room temperature is a suitable temperature for the temperature T_{R}. The term “room temperature” is meant in a broad sense to correspond to the temperature of the environment surrounding the pressure vessel or any suitable storage or work area. This so-called room temperature may be selected according to a desirable initial and final temperature. For example, it may be desirable to select the room temperature T_{R} to correspond to an expected storage temperature for the optical element after it is enhanced by the method of the invention. The ramp-up 12 and ramp-down 14 portions of the temperature profile 10 may have a maximum T₁ less than 250° C. according to some particular applications of this method. In other applications of this method, the maximum T₁ of the ramp-up-ramp-down temperature profile may be less than 100° C. The lower maximum temperatures are desirable for cases in which an optical fiber that has a coating is being treated because the coating can be damaged at the higher temperatures. In some applications, the ramp-up-ramp-down portion of the temperature profile may have a maximum T₁ less than 250° C. while the spike portion of the temperature profile has a maximum T₂ that is greater than 250° C. As the temperature is changed, the hydrogen partial pressure may be allowed to vary according to the ideal gas law. One may further vary the pressure, as desired. All such cases are within the scope of this invention. The scope of the invention is not limited to the specific shape of the temperature profile 10 and is not limited to the specific temperatures of the maxima T₁ and T₂. These detailed descriptions provide examples which are helpful to understand the broader concepts of the invention.

The method of enhancing photosensitivity of an optical element according to this embodiment of the invention may also include regulating pressure of the hydrogen-rich atmosphere in the confinement chamber over at least a portion of the treatment time (see FIG. 2). In one aspect of this embodiment of the invention, a hydrogen partial pressure of the hydrogen-rich atmosphere is decreased 24 during a treatment period of time while the temperature of the hydrogen-rich atmosphere is being increased 12. The hydrogen partial pressure may be decreased more rapidly 26 during a portion of the treatment time that at least partially coincides with the increasing temperature portion 18 of the spike 16 of the temperature profile 10 of the hydrogen-rich atmosphere. The hydrogen partial pressure is then maintained substantially constant 28 during a treatment time period that at least partially coincides with the temperature decreasing portion 20 of the spike 16 of the temperature profile 10. The invention is not limited to only maintaining the hydrogen partial pressure constant as indicated by reference numeral 28. If additional enhancement of hydrogen loading is desired during the later stages of the treatment, one may increase 29 the hydrogen partial pressure while the temperature is decreased without departing from the scope or spirit of the invention. In addition a variation of hydrogen partial pressure may have a different rate along the treatment portion 30 that is subsequent to the portion 29.

The method of enhancing photosensitivity of an optical component in which the temperature of the hydrogen-rich atmosphere is varied over a treatment period and in which temperature and pressure of the hydrogen-rich atmosphere are varied over a treatment period has advantages and effects which may be understood in terms of laws of diffusion and solubility of hydrogen into the optical element. However, this invention is not limited to the correctness of the particular laws of diffusion and solubility summarized herein. An understanding of the theoretical diffusion and solubility of the loading of hydrogen into the optical element being treated according to this method is useful for helping one to select particular temperature variation profiles and temperature and pressure variation profiles for the particular case of interest. All such cases are contemplated as being within the scope of this invention.

Diffusion is a measure of how quickly the hydrogen moves into the optical element and the hydrogen solubility of an optical element is a measure of how much hydrogen can be absorbed into the optical element. Both the diffusion and solubility are strongly temperature dependent. The diffusion D of hydrogen into the optical element as a function of time can be represented as

D=2.83×10⁻⁴ exp−(a/T) cm²/s,

where a is 4.833 K and T is temperature in Kelvin.

One can see from this equation that the diffusion coefficient increases as the temperature increases. A larger diffusion coefficient means that hydrogen diffuses more rapidly into the optical element, thus requiring less time for a given amount of hydrogen to diffuse into the optical element.

In contrast to diffusion, the solubility of the optical element decreases as the temperature increases. Therefore, as the temperature of the optical element increases, the amount of hydrogen that the optical element can absorb decreases. If one were to hydrogen load an optical element at a temperature which is much higher than the ambient room temperature, or a desired storage temperature for the optical element, once the optical element is removed from the hydrogen-rich environment into the lower temperature environment, hydrogen tends to quickly diffuse out of the optical element.

According to an embodiment of this invention, the temperature of the hydrogen-rich environment is ramped-up to a maximum temperature and subsequently decreased to a lower temperature. This ramping technique utilizes both the high diffusion rate at high temperatures and the high amount of solubility at lower temperatures. This aspect of Applicants' invention has the added benefit that the diffusion rate is lower at the end of the treatment period than at the higher temperature intervals of the treatment period. The lower diffusion rate at the end of the treatment period leads to a longer lifetime for the photosensitivity enhancement of the optical element after it is removed from the hydrogen-rich environment.

As the temperature of the hydrogen-rich atmosphere is ramped-up, the hydrogen in the fiber heats up. The hydrogen starts to move into the fiber more quickly as the temperature increases. At some temperature, the solubility of the hydrogen in the fiber decreases to such an amount that no more hydrogen can move into the fiber even though the diffusion coefficient continues to increase. If one increases the temperature past this point, hydrogen that is already in the fiber will start to diffuse out of the fiber. In one implementation of this embodiment of the invention, the temperature of the hydrogen-rich atmosphere is increased until this inflection point is reached and then the temperature is decreased. As the temperature decreases, more hydrogen absorbs into the fiber due to the increased solubility. Once the optical element has cooled down to room temperature, the optical element can be removed from the hydrogen-rich environment.

One may select the particular temperature ramp profile according to the amount of photosensitivity required for the optical element. For example, the temperature for an optical fiber for use in the fabrication of fiber Bragg gratings may be ramped up in temperature to a chosen value, for example, 150° C., while the hydrogen pressure within the pressure vessel is increased, or allowed to increase. At very low hydrogen pressures, the temperature can be rapidly increased above 250° C. for a brief interval to allow excess hydrogen to escape from the fiber. This enhances the stability of periodic structures written into the optical fiber after its photosensitivity is enhanced. One may select a particular form of temperature profile and/or temperature and pressure profiles over the treatment period to tailor the amount of hydrogen loading in the optical element, thus controlling its photosensitivity. Certain types of optical elements may require only small amounts of photosensitivity enhancement. For example, high photosensitivity optical fibers that have recently become available may require only a small amount of photosensitivity enhancement by hydrogen loading.

Another aspect of Applicants' invention is a method of producing an optical element that includes exposing the optical element to a hydrogen-rich atmosphere for a treatment period of time. As in the first embodiment, the optical element may be a bulk optical component or an optical waveguide. The optical waveguide may be a planar waveguide or an optical fiber, for example. The optical fiber may include high or low photosensitivity optical fibers. A suitable optical fiber is a germanium-doped optical fiber. The method of producing the optical element includes varying temperature of the hydrogen-rich atmosphere during the treatment period of time. The optical element is also irradiated with electromagnetic radiation, such as ultra-violet or infrared radiation. The irradiation has intensity variations which produce refractive index variations in the optical element. For example, periodic structures, such as Bragg grating structures, may be produced by the coherent superposition of two or more ultra-violet or infrared beams resulting in a periodic interference pattern to write a Bragg grating into an optical fiber. However, this aspect of the invention is not limited to the particular patterns of refractive index variations written into the optical elements. The temperature of the hydrogen-rich atmosphere may be varied in ways similar to those described above in regard to the first embodiment of the invention of enhancing photosensitivity of an optical element. Similarly, the pressure may be varied similar to that of the first embodiment as well as temperature and pressure being varied simultaneously.

Other aspects of the invention include optical elements that have enhanced photosensitivity according to the first embodiment and optical elements produced according to the second embodiment of the invention.

Another embodiment of the invention is directed to a method of producing an optical element and includes exposing a high photosensitivity optical fiber to a hydrogen-rich atmosphere for a treatment period of time. The high photosensitivity optical fiber may be selected from high photosensitivity optical fibers currently available, such as germanium-doped optical fibers which have a core doped at least with 4.5 mol % GeO₂.

A hydrogen partial pressure of the hydrogen-rich atmosphere is regulated during the treatment period of time, particularly, the hydrogen partial pressure is maintained below 1 atmosphere during the treatment period of time according to this embodiment of the invention. One may also maintain the temperature of the hydrogen-rich atmosphere below about 100° C. according to this embodiment of the invention. One may further maintain the temperature of the hydrogen-rich atmosphere below about 75° C. according to this embodiment of the invention. The optical fiber is irradiated with actinic radiation to “write” desired refractive index variations in the optical fiber. Bragg gratings are examples of particular structures which may be written into the optical fibers.

Maintaining hydrogen partial pressures below 1 atmosphere avoids the costs, complexity and danger of having to deal with high pressure hydrogen environments. Similarly, the lower temperatures such as below 100° C. or below 75° C. allows sufficient hydrogen loading with a high photosensitivity optical fiber while avoiding the costs, danger and complexity of having to treat optical fibers at high temperature and/or pressure. The lower temperatures also have an advantage of avoiding damage to optical fibers which typically have coatings that are damaged by prolonged exposure to high temperatures. While the hydrogen partial pressure of the hydrogen-rich atmosphere is maintained below 1 atmosphere, one may maintain the temperature of the hydrogen-rich atmosphere substantially constant over the treatment period. However, this aspect of the invention is not limited to only maintaining constant temperature and/or pressure. One may vary the temperature and/or pressure, for example, similar to that of the first embodiment of the invention, but also maintaining the pressure below 1 atmosphere and the temperature below about 100° C.

Although the invention is described above in reference to exemplary embodiments, one of ordinary skill in the art would recognize from the teachings herein that many modifications to the exemplary embodiments are possible without materially departing from the novel teachings and advantages of this invention. All such modifications are intended to be included within the scope of this invention, as defined in the following claims.

We claim:

1. A method of enhancing photosensitivity of an optical element, comprising:
disposing said optical element in a confinement chamber;
introducing a hydrogen-rich atmosphere into said confinement chamber; and
regulating a temperature of said hydrogen-rich atmosphere over a treatment time,
wherein said regulating a temperature comprises increasing said temperature of said hydrogen-rich atmosphere over a portion of said treatment time.

2. A method of enhancing photosensitivity of an optical element according to claim 1, wherein said regulating a temperature of said hydrogen-rich atmosphere comprises decreasing said temperature of said hydrogen-rich atmosphere over a second portion of said treatment time subsequent to said increasing said temperature.

3. A method of enhancing photosensitivity of an optical element according to claim 2,
wherein a surrounding atmosphere that is external to said confinement chamber is at a room temperature, and
a temperature of said hydrogen-rich atmosphere prior to said increasing said temperature of said hydrogen-rich atmosphere is substantially equal to said room temperature of said surrounding atmosphere.

4. A method of enhancing photosensitivity of an optical element according to claim 3,
wherein a temperature of said hydrogen-rich atmosphere subsequent to said decreasing said temperature of said hydrogen-rich atmosphere is substantially equal to said room temperature of said surrounding atmosphere.

5. A method of enhancing photosensitivity of an optical element according to claim 1, further comprising regulating a pressure of said hydrogen-rich atmosphere over said treatment time,
wherein said regulating a pressure of said hydrogen-rich atmosphere comprises decreasing a hydrogen partial pressure of said hydrogen-rich atmosphere during said increasing said temperature of said hydrogen-rich atmosphere.

6. A method of enhancing photosensitivity of an optical element according to claim 2,
wherein said regulating a temperature of said hydrogen-rich atmosphere comprises increasing said temperature of said hydrogen-rich atmosphere over a third portion of said treatment time, subsequent to the first-mentioned portion of said treatment time, at a rate of increase that is greater than a rate of increase of the first-mentioned increasing said temperature.

7. A method of enhancing photosensitivity of an optical element according to claim 6, wherein said regulating a temperature of said hydrogen-rich atmosphere comprises decreasing said temperature of said hydrogen-rich atmosphere over a fourth portion of said treatment time, prior to said second portion of said treatment time, at a rate of decrease that is greater in magnitude than a rate of decrease of the first-mentioned decreasing said temperature.

8. A method of enhancing photosensitivity of an optical element according to claim 1, wherein said optical element is an optical waveguide.

9. A method of enhancing photosensitivity of an optical element according to claim 8, wherein said optical waveguide is an optical fiber.

10. A method of enhancing photosensitivity of an optical element according to claim 4, wherein a ramp-up-ramp-down temperature profile of said hydrogen-rich atmosphere has a maximum value less than 250° C.

11. A method of enhancing photosensitivity of an optical element according to claim 10, wherein said ramp-up-ramp-down temperature profile has a maximum value less than 100° C.

12. A method of enhancing photosensitivity of an optical element according to claim 4, wherein a ramp-up-ramp-down portion of a ramp-up-spike-ramp-down temperature profile has a maximum less than 250° C., and
a spike portion of said ramp-up-spike-ramp-down temperature profile has a maximum greater than 250° C.

13. A method of enhancing photosensitivity of an optical element according to claim 14, wherein a ramp-up-ramp-down portion of a ramp-up-spike-ramp-down temperature profile has a maximum less than 100° C., and a spike portion of said ramp-up-spike-ramp-down temperature profile has a maximum greater than 250° C.

14. A method of producing an optical element, comprising:
exposing said optical element to a hydrogen-rich atmosphere for a treatment period of time;
varying a temperature of said hydrogen-rich atmosphere during said treatment period; and
irradiating said optical element with electromagnetic radiation.

15. A method of producing an optical element according to claim 14, wherein said varying a temperature of said hydrogen-rich atmosphere comprises a ramp-up in temperature, followed by a ramp-down in temperature.

16. A method of producing an optical element according to claim 15, wherein said varying a temperature of said hydrogen-rich atmosphere comprises a spike-up and spike-down temperature profile.

17. A method of producing an optical element according to claim 16, wherein said spike-up and spike-down temperature profile has a maximum greater than 250° C.

18. A method of producing an optical element according to claim 15, further comprising varying a partial pressure of said hydrogen-rich atmosphere during said ramp-up and ramp-down in temperature.

19. A method of producing an optical element according to claim 18, wherein said varying a partial pressure of said hydrogen-rich atmosphere comprises decreasing said partial pressure while said temperature is being ramped up.

20. A method of producing an optical element according to claim 15, further comprising terminating said exposing said optical element to said hydrogen-rich atmosphere,
wherein said temperature of said hydrogen-rich atmosphere is substantially at a room temperature upon said terminating said exposing said optical element to said hydrogen-rich atmosphere.

21. A method of producing an optical element according to claim 14, wherein said optical element is an optical waveguide.

22. A method of producing an optical element according to claim 21, wherein said optical waveguide is an optical fiber.

23. A method of producing an optical element according to claim 22, wherein said irradiating said optical element with electromagnetic radiation causes a pattern of refractive index variations in said fiber.

24. An optical element treated by the method of claim 1.

25. An optical element treated by the method of claim 2.

26. An optical element treated by the method of claim 4.

27. An optical element treated by the method of claim 6.

28. An optical element treated by the method of claim 9.

29. An optical element treated by the method of claim 14.

30. An optical element produced by the method of claim 15.

31. An optical element produced by the method of claim 19.

32. An optical element produced by the method of claim 20.

33. An optical element produced by the method of claim 22.

34. A method of producing an optical element, comprising:
exposing a high photosensitivity optical fiber to a hydrogen-rich atmosphere for a treatment period of time;
regulating a hydrogen partial pressure of said hydrogen-rich atmosphere during said treatment period of time; and
irradiating said high photosensitivity optical fiber with electromagnetic radiation,
wherein said regulating a hydrogen partial pressure comprises maintaining said hydrogen partial pressure below one atmosphere during said treatment period of time.

35. A method of producing an optical element according to claim 34, further comprising maintaining a temperature of said hydrogen-rich atmosphere below about 100° C.

36. A method of producing an optical element according to claim 35, wherein said temperature of said hydrogen-rich atmosphere is maintained below about 75° C.

37. A method of producing an optical element according to claim 34, wherein said high photosensitivity fiber is a germanium-doped optical fiber.

38. A method of producing an optical element according to claim 37, wherein said germanium-doped optical fiber comprises at least 4.5 mole % GeO₂.

39. An optical element produced by the method of claim 34.

40. An optical element produced by the method of claim 35.

41. An optical element produced by the method of claim 38.
